(19) United States
(12) Patent Application Publication
(10) Pub. No.: US 2013/0040795 A1
(43) Pub. Date: Feb. 14, 2013

(54) PROCESS FOR ASSEMBLING A CARDBOARD BLANK AND PLANT FOR THE IMPLEMENTATION THEREOF

(71) Applicant: Pascal Murano, Octeville Sur-mer (FR)

(72) Inventor: Pascal Murano, Octeville Sur-mer (FR)

(73) Assignee: SIDEL PARTICIPATIONS, Octeville Sur-mer (FR)

(21) Appl. No.: 13/642,609

(22) PCT Filed: May 18, 2011
(86) PCT No.: PCT/FR11/51124

§ 371 Date: Oct. 22, 2012

(30) Foreign Application Priority Data
May 21, 2010 (FR) 10 53993

(51) Int. Cl. B31B 1/88

(52) U.S. Cl. 493/53

(57) ABSTRACT

Plant and process for assembling, in the form of an open-ended box (27; 31), a cardboard blank (1) for the manufacture of a box of the American box type, said blank (1) comprising two opposite walls, joined by their lateral edges, each of the walls comprising two adjacent sides of the box to be formed, the two adjacent sides having different lengths, said process consisting in using three assembly arms (10, 11, 12), the three arms being actuated, in pairs, by control means (5) following a first operating mode (I) or a second operating mode (II).

The invention relates to a method for assembling a cardboard blank to be used in the production of a slotted box (also referred to as an “American box”); it also relates to a facility for implementing the method of the invention.

A cardboard blank used to produce a slotted box comprises two flat opposing walls, connected at their lateral edges. Each of these walls consists of two adjacent sides of the box to be formed, and the two adjacent sides are of different lengths (for example a small side and a large side of the box).

Such a blank allows forming an open-ended box, which can be filled with the products to be packaged and then closed.

A method for assembling cardboard blanks of this type is known from document FR 2 907 100, comprising a first step of removing from a warehouse, by means of a first extracting arm, a blank which is in a certain position.

This “certain” position is chosen beforehand so that the open-ended box formed (at the end of the process) is presented in an orientation such that it can, for example, be filled by introducing items laterally (for example bottles that are on their sides). In such a case, the box is arranged such that the items written on the top are readable from bottom to top, or from top to bottom, depending on what direction the products are to be laterally introduced into the obtained boxes.

The method described in document FR 2 907 100 also includes the following steps for assembling the open-ended box:
applying a first arm to the first side of the first wall of a cardboard blank, the first side having a different length than that of the second side included in each wall of a cardboard blank;
applying a second arm to the second side of the second wall of the blank,
actuating the holding means provided on said first and second arms,
and assembling the cardboard blank to form the open-ended box by maneuvering one of the two first or second arms, rotating it on an axis to open the blank.

Such a method yields open-ended boxes that are correctly oriented for filling with products downstream. Such a method is therefore satisfactory for companies which package products in slotted boxes.

There is one case, however, where the method described above is unsuitable: it does not yield correctly oriented boxes at the end of the method when the cardboard blanks stacked in the magazine are blanks that have been made upside down.

The invention results from the need to create a facility that is able to assemble such blanks when they are presented upside down.

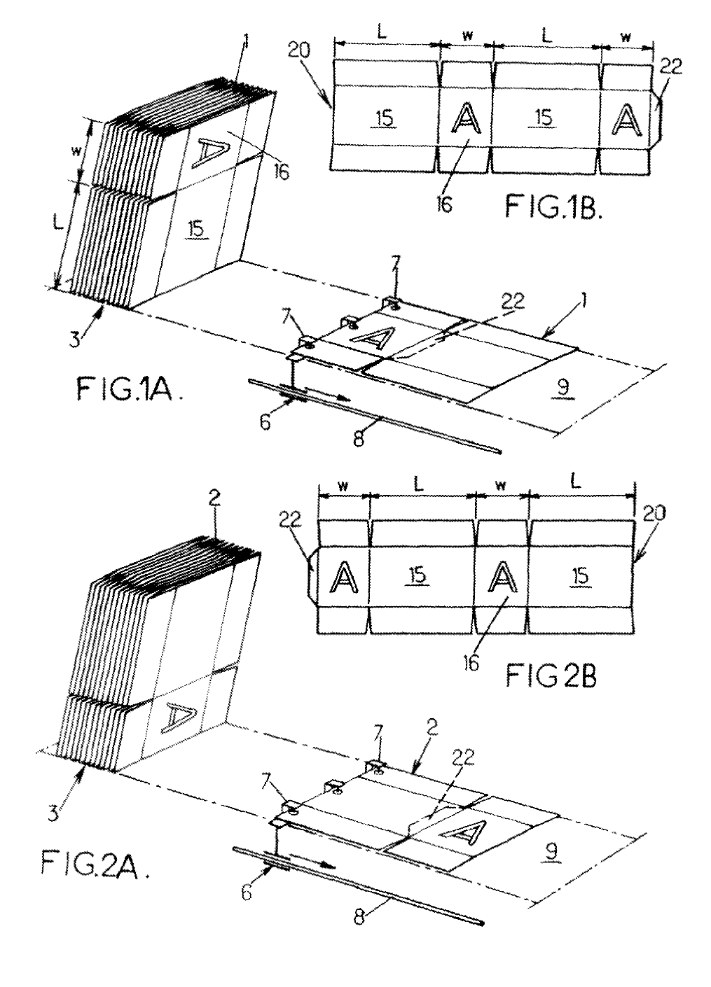

FIG. 1A shows a cardboard blank 1 on which the lettering is in the standard manner, and FIG. 2A shows a cardboard blank 2 on which the lettering is inverted (upside down).

One will note in FIG. 1A that the small side 16 of the box to be shaped, of length w, is at the top of the cardboard blank, while in FIG. 2A the small side 16 of the box is at the bottom.

The blank 1 shown in FIG. 1A is obtained from an initial unfolded blank 20, shown in FIG. 1B. Note that A appears on the small sides 16 of the initial blank 20, and that this A is applied while the initial blank 20 is unfolded with its gluing tongue 22 positioned to the right.

The blank shown in FIG. 2A is obtained from an initial unfolded blank 20 identical to the one represented in FIG. 1B, but the initial blank 20 is inverted when the lettering A is applied to the small sides 16. The lettering A is applied while the initial blank 20 is unfolded with its gluing tongue 22 positioned to the left.

The initial blanks 20 have large sides 15 of length L alternating with small sides 16 of length w, two of each, to form a box.

The folded cardboard blanks (with standard or inverted lettering) are obtained by folding towards each other the large side 15 and small side 16 that are furthest apart and attaching them to each other by gluing the tongue 22 onto the edge of the large side 15.

This results in blanks comprising two superimposed walls. Each wall includes a large side 15 and a small side 16, and one of the walls comprises the tongue 22 which is located in a central portion between the edges of the wall.

The box blanks 1 or 2 are introduced into a magazine 3 in a predetermined reading direction.

The same magazine may therefore be used to hold batches of the blanks represented in FIGS. 1A and 2A.

In the method for assembling cardboard blanks according to the invention, the blanks 1 or 2 are presented flat on a conveyor.

To obtain this flat position, the blanks 1 or 2 are collected from the magazine 3 by an arm, of the type described in patent application FR 2 907 100 cited above (arm not shown in the figures), which rotates on an axis to place the blank flat on the conveyor.

One will note in FIGS. 1A and 2A that the standard blanks 1 or inverted blanks 2 when placed flat on the conveyor are not in the same orientation:

the standard blank 1 presents the small side 16 on the left while the inverted blank 2 presents the small side 16 on the right.

When the same assembly method is applied to the two blanks, standard 1 and inverted 2, boxes are obtained which are oriented differently: the box obtained from the standard blank 1 rests on the conveyor on its large side 15, while the box obtained from the inverted blank 2 rests on the conveyor on its small side 16.

There is another problem that led to the invention. This is a problem related to the gluing of the tongue 22 when assembling two types of blank.

When gluing the tongue 22, the glue may overflow so that the two walls of the blank also end up glued together.

To assemble such a blank, it is necessary to provide technical means that are sufficiently distributed on the blank and sufficiently powerful to detach the two walls and assemble the blank.

The invention aims to achieve this by proposing a method and a facility that overcome the tongue gluing problem.

The invention also aims to overcome the problems of the prior art and proposes a method and a facility for obtaining open-ended boxes which are always oriented in the same direction, independently of whether the blanks (presented in the magazine) are blanks having standard printing or inverted printing.

The invention therefore relates to a method for assembling, in the form of an open-ended box, a cardboard blank for the production of a box of the slotted box type, said blank comprising two opposite walls joined by their lateral edges, each of the walls comprising two adjacent sides of the box to be formed, the two adjacent sides having different lengths, said blanks presenting standard or inverted printing oriented in the same direction, said method making use of three assembly arms. Such a method is described in document WO 2004/014730.

The method of the invention is notable in that it makes use of control means which actuate said arms according to:
a first operating mode ensuring the assembly of blanks with standard printing, said first operating mode making use of a first and a second assembly arm, by traction with the box at a point of reference, and
a second operating mode ensuring the assembly of blanks with inverted printing, said second operating mode making use of a third arm and one of the arms from among the first and second assembly arms, by traction at said point of reference.

In concrete terms, in an embodiment which will be described and illustrated below, as the two adjacent sides of the box are of different lengths, they define what can be referred to as a “large side” of the box and a “small side” of the box, the large side being the one of the greatest length.

The first operating mode ensures, for example, the cooperation of the first arm with a “large side” of the box and the cooperation of the second arm with a “small side” of the box.

As for the third arm, it cooperates with the other “large side”. The first arm can be longitudinally maneuvered to longitudinally displace the large side it is holding.

As for the technical effect obtained by the solution of the invention, it should be noted that the presence of control means associated with three assembly arms allows the implementation of two operating modes.

The operating modes command the use of the arms in pairs, to ensure two different movements for assembling the boxes.

With two operating modes it is possible to have an operating mode dedicated to one category of blanks (standard or inverted category), and each operating mode uses the two arms closest to the tongue gluing point to ensure assembly of the blank regardless of whether or not its walls have been glued together.

The method thus overcomes the disadvantages of the prior art and allows achieving the objectives initially established.

The method of the invention may also comprise the following characteristics, separately or together:
the first operating mode commands:
   the application of a first arm, a holding arm, against a first side of one of said opposite walls, and
   the application of a second arm, an assembly arm, against a second side of the other of said opposite walls;
the second operating mode commands:
   the application of a first arm, a holding arm, against a first side of one of said opposite walls, and
   the application of a third arm, an assembly arm, against a first side of the other of said opposite walls.

The invention also relates to a facility for implementing the method as defined above, allowing the assembly, in the form of an open-ended box, of a cardboard blank of the slotted box type, said blank comprising two opposite walls joined by their lateral edges, each of the walls comprising two adjacent sides of the box to be formed, the two adjacent sides having different lengths, said blanks having standard or inverted printing oriented in the same direction,

said facility comprising an assembly station for assembling blanks into open-ended boxes,

said assembly station comprising three arms, and control means which can be actuated for first and second operating modes, placing the assembled box in a same frame of reference whether it is a standard blank or an inverted blank.

The facility is notable in that:
the first operating mode assembles blanks with standard printing by making use of a first and a second assembly arm, and
the second operating mode assembles blanks with inverted printing by making use of a third arm and one of the arms from among the first and second assembly arms.

The facility of the invention may also comprise the following characteristics, separately or in any combination:
among the three arms, the first arm is a first holding arm that maintains in position one of the walls of the blank lying horizontally, and the first holding arm is mounted to move along a substantially vertical axis and along a substantially horizontal axis;
the first arm comprises, at one of its ends, a flap that moves between a position where it is inactive and a position where it presses against an edge of said blank;
among the three arms, the second arm is an assembly arm that assembles the blank lying horizontally, and the second arm is an arm mounted to pivot on a substantially horizontal axis;
the second assembly arm is mounted to overhang a slider bed on which said cardboard blank travels;
among the three arms, the third arm is an assembly arm that assembles the blank laying horizontally, and the third arm is an arm which is mounted to move along a vertical axis;
the facility comprises blocking means to stop the vertical movement of the third arm at a height substantially equal to the length of the smallest side of the blank, said means being operable when the third arm is rising;
the facility comprises a numerical control (NC) axis ensuring the vertical displacement of said third arm,
the third arm is mounted to pivot slightly at one end of an actuator;
said assembly station comprises a flexible blade, equipped with an abutment acting as a point of reference for positioning and holding in place the front edge of a blank.

The invention is described in a sufficiently clear and complete manner in the following description to enable its execution, accompanied by drawings in which:

FIGS. 1A and 1B relate to a blank having standard lettering; FIG. 1A shows a perspective view of a magazine in which such blanks are stacked as well as a blank placed flat on a slider bed and being conveyed to an assembly station, and FIG. 1B shows a front view of an initial unfolded blank from which a standard blank is obtained;

FIGS. 2A and 2B relate to a blank having inverted lettering; FIG. 2A shows a perspective view of a magazine in which such blanks are stacked as well as a blank placed flat on a slider bed and being conveyed to an assembly station, and FIG. 2B shows a front view of an initial unfolded blank from which an inverted blank is obtained;

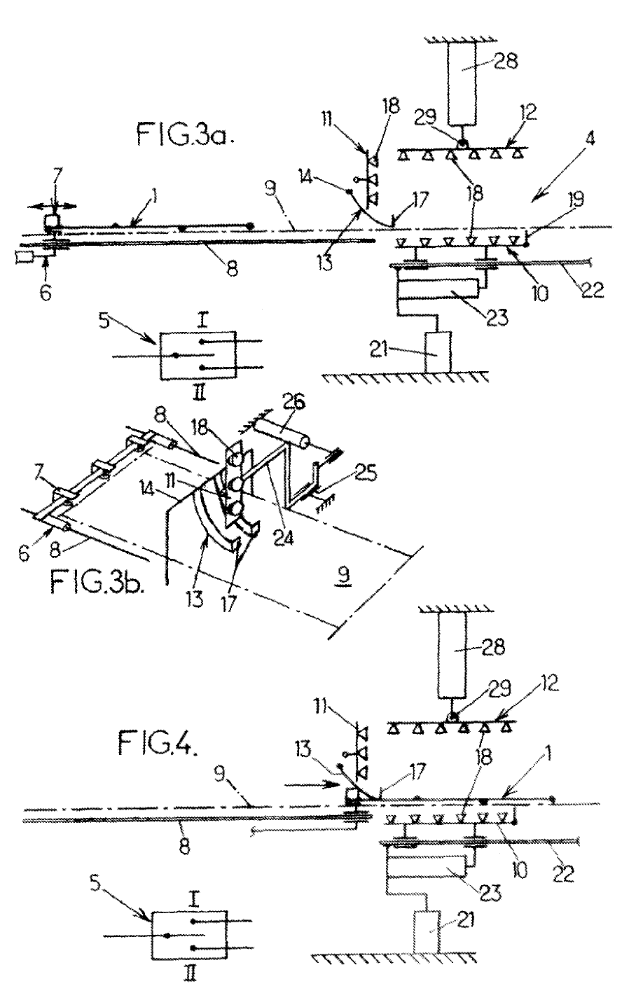

FIG. 3a is a schematic representation of an assembly station viewed from the side, to which a standard blank is being supplied;

FIG. 3B is a schematic perspective representation of how an arm of the assembly station is mounted;

FIG. 4 is a schematic representation of the assembly station of FIG. 3A, and shows the standard blank of the type illustrated in FIG. 1A, inside the assembly station;

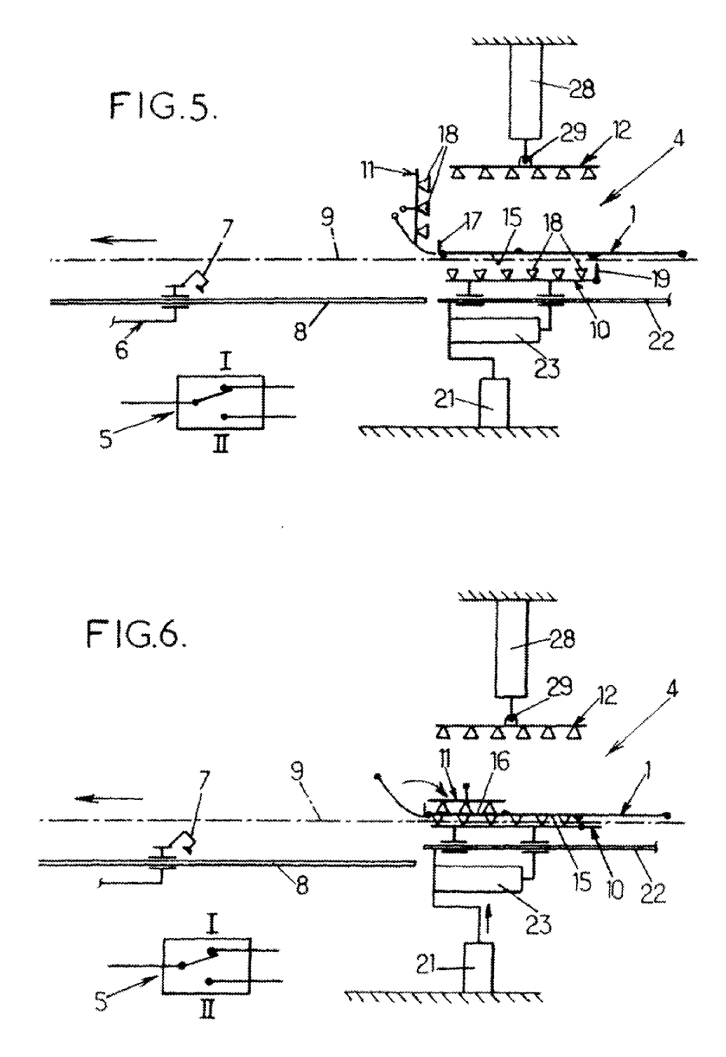

FIG. 5 is a schematic representation of the assembly station of FIG. 3A, and shows a first step of the method for assembling the standard blank to create an open-ended box;

FIG. 6 is a schematic representation of the assembly station of FIG. 3A, and shows a second step of the method for assembling the standard blank to create an open-ended box;

FIG. 7 is a schematic representation of the assembly station of FIG. 3A, and shows an ultimate step of the method for assembling the standard blank to create an open-ended box;

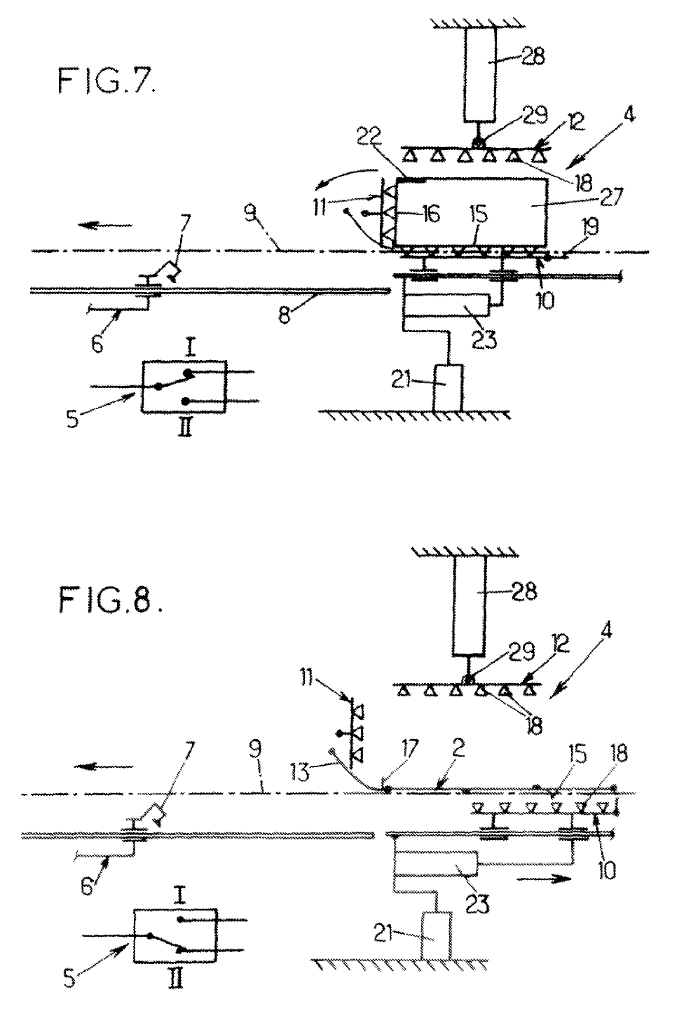

FIG. 8 is a schematic representation of the assembly station of FIG. 3A, in a side view, inside of which is an inverted blank of the type illustrated in FIG. 2B;

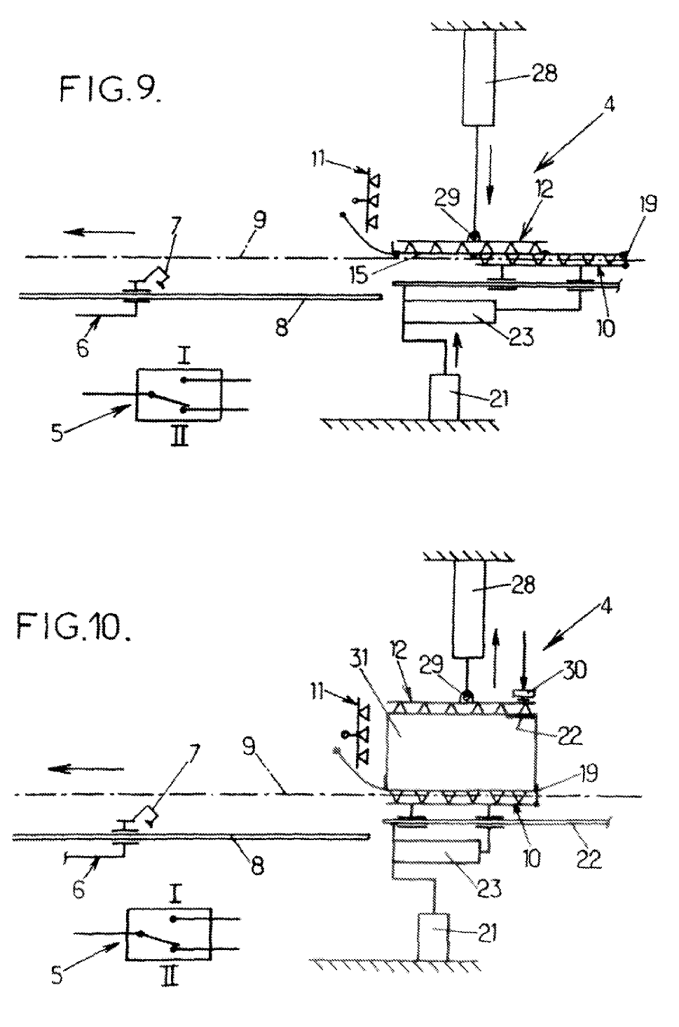

FIG. 9 is a schematic representation of the assembly station of FIG. 3A, and shows a first step of the method for assembling the inverted blank to create an open-ended box;

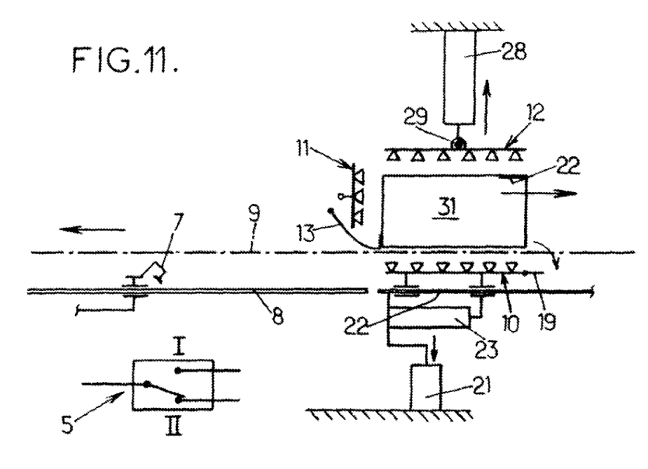

FIG. 10 is a schematic representation of the assembly station of FIG. 3A, and shows a second step of the method for assembling the inverted blank to create an open-ended box;

and FIG. 11 is a schematic representation of the assembly station of FIG. 3A, and shows the removal of the box obtained from an inverted blank.

The facility of the invention, which will now be described, operates according to two operating modes for assembling two respective types of cardboard blanks, such as those presented above with reference to FIGS. 1A, 1B, 2A and 2B.

To do this, the facility represented in FIG. 3A comprises an assembly station 4 comprising three assembly arms 10, 11 and 12, as well as control means 5 which allow actuating two different operating modes I and II of the facility, each operating mode making use of two of the three arms 10, 11, 12 comprised in the assembly station 4.

The arms 10, 11, 12 are industrial parts adapted to the format of the sides of the boxes to be assembled. They may therefore have variable lengths.

The control means 5 may be a control panel, such as an electronic module, equipped with a selection button (called a switch in the rest of the description) which, when it is set to one position, initiates the first operating mode, and which, when it is set to the other position, initiates the second operating mode of the facility.

The switch may be actuated manually by an operator who observes that the cardboard blanks in the magazine are of the standard or inverted type.

We will now describe the arrival of a blank at the assembly station 4 of the facility.

FIG. 3 shows a standard blank 1 which has been taken from the magazine 3 by a gripping device 6 with clips 7, said device 6 being movably mounted on a rail 8.

The rail 8 follows the slider bed 9 on which the cardboard blank 1 lies horizontally as it advances.

A gripping device similar to device 6 may be implemented at the exit from the assembly station, to remove the formed boxes. This removal device is also mounted on a rail 8. Such a device has not been represented in the figures, for clarity.

The slider bed 9 may, for example, be implemented as two parallel beams, spaced apart in a manner that allows a cardboard blank to lie flat on it.

The assembly station 4 comprises a curved spring blade 13 at its entrance, having the function of preventing the return of a box that passes beyond it. One of the ends 14 of the “return prevention” blade 13 allows a slight rotation of the blade, and its other (free) end is positioned at the level of the slider bed 9; this free end has an abutment 17 acting as a stop; it is in the form of a vertical tongue that holds the front edge of the blank in place and acts as a reference point for positioning said blank in the folding station.

Realized in this manner, the abutment 17 of the blade 13 does not come interfere when a blank 1 arrives inside the assembly station 4, as it rises when the arriving blank 1 pushes against it. The blade 13 thus allows a blank 1 to pass inside the station 4 (see FIG. 4).

However, once the blank 1 has moved beyond the abutment 17 on the blade 13, this abutment 17 elastically returns to the plane of the slider bed 9.

When the gripping device 6 has advanced beyond the blade 13, it returns in the other direction. The end of the blank 1 then comes in contact with the abutment 17 and the blank 1 is automatically released from the clips 7 of the carrying device 6 (see FIG. 5).

The blank 1 then presses against the abutment 17 of the blade 13, which holds the blank in place in the assembly station 4 and, more precisely, at the point of reference for positioning the cardboard blank in the assembly station 4.

Whether the control means 5 are actuated for the first I or second II operating mode, the standard 1 or inverted blanks 2 all arrive at the assembly station 4 in the manner just described, and they are held in place in the same manner by the abutment 17 of the blade 13, which acts as the point of reference.

This is why, in FIGS. 3 and 4, the switch for the control means 5 has been represented between the two positions I and II (each position associated with an operating mode).

In FIGS. 3 and 4, the switch of the control means 5 could just as well have been represented as indicating operating mode I or operating mode II, without this changing the implementation of the supplying device 6 nor of the holding blade 13.

FIGS. 5 to 7 show the operation of the facility, and particularly the assembly station when the control means 5 are actuated for the first operating mode I.

The first operating mode I triggers the use of two arms 10 and 11, the combined use of these arms 10 and 11 being dedicated to the assembly of standard blanks 1.

We will now describe, with reference to FIGS. 5 to 7, each of the arms 10 and 11 and their respective movements, as well as the consequences of these movements on the opening and assembling of the standard blank 1.

The first arm 10 is an arm which has the function of maintaining the wall of the blank 1 which is facing the slider bed 9.

It will be seen in the following description that the first arm 10 is also used in the second operating mode, and that it has this same function within the context of the second operating mode.

The first arm 10 is fitted with suction cups 18, which may be actuated to retain a wall of the blank 1 using suction and, in particular, a large side 15 of this wall.

For this purpose, the first arm 10 has a length substantially equal to the length L of the large side.

It also has a flap 19 at its downstream end, which is only useful in the context of the second operating mode II. The flap 19 is pivotably or retractably mounted on one of its ends.

The first arm 10 is mounted to move vertically due to the action of an actuator 21.

An upward vertical displacement presses the suction cups 18 against the large side 15 of the wall of the blank 1.

A downward vertical displacement disengages the arm 10 once the open-ended box is formed, so that the box can be taken to a filling station for example.

The first arm 10 can also be displaced in a horizontal translational movement. This movement only occurs, however, in the second operating mode.

To achieve this, the arm 10 is mounted to move freely on a horizontal rail 22—meaning in the same direction as that of the slider bed 9—due to the action of a second actuator 23.

The second arm 11, which is also actuated in the context of the first operating mode I, also comprises suction cups 18.

The second arm 11 is assembled to overhang the slider bed, on a frame 24 having a bayonet shape which allows an arriving cardboard blank 1 to pass into the assembly station 4.

The second arm 11 is designed to be applied against a small side 16 of a wall of the blank which is opposite the wall the first arm 10 is pressing against.

To achieve this application, the frame 24 is mounted to pivot on a shaft 25 transverse to the slider bed (FIG. 3B), and the rotation of this shaft 25 is controlled by an actuator system 26.

The first operating mode I of the facility will now be described.

When a standard blank 1 reaches the assembly station 4, the first arm 10 is in the lowered position (below the level of the slider bed 9) and the flap 19 of the arm 10 is pivoted to return to the same plane as that of the first arm 10. The second arm 11 is retracted, meaning it is above the slider bed 9.

When the blank 1 is placed against the abutment 17 of the blade 13, which acts as a point of reference and the point where it is held in place in the assembly station 4, the first arm 10 is raised to apply the suction cups 18 against the large side 15 of the wall resting on the slider bed 9 (FIG. 6).

At the same time as the first arm 10 is raised, the second arm 11 is pivoted to press against the small side 16 of the opposite wall of the blank. To do this, the frame 24 is pivoted by the actuator system 26.

The suction cups 18 are then actuated so that they firmly hold the two sides of the blank they are applied to.

At this point, one will note that one of the two sides the suction cups are applied to is the small side bearing the tongue 22 glued to an adjacent large side of the blank. In this manner, the suction force exerted by the second arm 11 is applied as close as possible to the glued tongue 22, and therefore to any glue overflow that may unfortunately be holding together the two walls of the blank 1.

To form the open-ended box, the frame 24 is then rotated in the reverse direction, to return to its position above the slider bed 9.

This rotational movement of the frame 24, associated with the effects of the suction cups 18, opens the blank 1 and forms the open-ended box 27 while ungluing the two walls of the blank if necessary.

To allow the removal of the box 27 formed in this manner, the suction cups 18 are deactivated and the arm 10 is returned to the retracted position, meaning below the level of the slider bed 9 (or in the lowered position).

The released box 27 can then be taken to another station further downstream.

The second operating mode II of the invention will now be described with reference to FIGS. 8 to 11.

In accordance with the invention, an inverted blank 2 arrives at the assembly station 4 in the manner described above in relation to FIG. 5.

The second operating mode II makes use of the first arm 10 and the third arm 12.

As was indicated above, in the second operating mode II the first arm 10 is moved translationally along a rail 22 parallel to the slider bed 9. The translational movement of the first arm 10 allows applying this arm 10 against the large side 15 of the wall of the blank resting on the slider bed 9.

The large side of the wall of the inverted blank 2 is offset relative to the arm 11 when the blank 2 is pressing against the abutment 17 of the spring blade 13, because this is an inverted blank.

The flap 19 also plays a role in this second operating mode.

Before describing the operation of the first arm 10 and the third arm 12, we will first refer to FIGS. 3 to 11 to describe the third arm 12.

The third arm 12 has the function of being applied against the large side 15 of the wall (of the blank 2) opposite the wall facing the slider bed 9.

To do this, the third arm 12 is suspended horizontally above the slider bed 9, facing the large side 15 of the wall (of the cardboard blank 2) opposite the wall facing the slider bed.

Similarly to the first arm 10 and second arm 11, it comprises suction cups 18 operable in a manner known to a person skilled in the art.

To ensure the application of the third arm 12 against the large side as defined above, this arm 12 is attached to a numerical control (NC) axis 28 ensuring its vertical displacement.

The NC axis here is an actuator positioned at a specific programmed distance. In other words, the position of the actuator is controlled by a program.

As can be seen, for example in FIGS. 7 and 8, the third arm 12 is mounted to pivot slightly on an end of the actuator 28 by means of a pivoting system 29 or a ball and socket joint. Thus the third arm is applied more easily against the large side of the wall, as this wall is not always perfectly horizontal on the slider bed 9 due to the folding of the cardboard blank 2. The pivoting system 29 allows a slight pivoting of the arm 12 so that it is better applied against the large side 15 of the wall.

There may also be a stop system 30, for stopping the travel of the arm when the arm is performing a bottom to top movement, for reasons which will be described below.

The second operating mode II of the invention will now be described with reference to FIGS. 8 to 11.

Once the inverted blank 2 is correctly positioned in the assembly station 4, meaning against the abutment 17 of the spring blade 13, the first arm 10 is moved translationally by the action of the actuator 23, until the arm 10 is facing the large side 15 of the wall facing the slider bed 9 (see FIG. 8).

The flap 19 is in the active position, meaning it forms an elbow with the arm 10.

The first arm 10 is then moved vertically to bring it against the large side 15 of the wall placed on the slider bed 9.

At the same time, the third arm 12 is lowered until it is applied against the large side of the opposite wall of the inverted blank (see FIG. 9).

In this position, the suction cups 18 of the arms 10 and 12 are actuated, and the flap 19 is applied against an edge of the blank 2.

To open the inverted blank 2 and form an open-ended box 31, the third arm 12 is raised at the same time as the first arm 10 performs a reverse translational movement (FIG. 10).

By performing the reverse translational movement, with the action of the flap 19 pushing against the edge of the blank 2, the first arm 10 brings the large side 15 it is gripping to face the large side 15 the third arm 12 is gripping.

As the blank is opened 2, the upward vertical movement of the arm 12 is stopped when said arm reaches the stop system 30.

The stop system 30 ensures a vertical displacement of the arm over a distance substantially equal to the size of the box 31, in a manner that does not damage the box as it is formed.

Once the stop system 30 is engaged, the suction cups 18 of arms 10 and 12 are deactivated and the flap 19 swings to the inactive position.

Then arm 12 is raised after retraction of the stop 30, and arm 10 is lowered, to allow the box 31 to be taken away (FIG. 11).

One will note that the second arm 12 holds the large side 15 of the blank 2 to which the tongue 22 is attached.

Thus the arm 12 holds a side of the blank which is as close as possible to the tongue 22.

This allows ungluing the two walls of the blank 2 as the open-ended box 31 is formed, in cases where the glue for the tongue 22 had overflowed and had glued the two walls together before the assembling step.

It can be seen from the above description that the invention overcomes the disadvantages of the prior art while achieving the initially stated objectives.

It should be understood, however, that the invention is not limited to the embodiment and implementation specifically described, and extends to any equivalent embodiment.

For example, in the above description, only the actuator 28 is a numerical control axis. All the actuators could be numerical control axes without leaving the scope of the invention.

1.-13. (canceled)

14. Method for assembling, in the form of an open-ended box, a cardboard blank for the production of a box of the slotted box type, said blank comprising two opposite walls joined by their lateral edges, each of the walls comprising two adjacent sides of the box to be formed, the two adjacent sides having different lengths, said blanks presenting standard or inverted printing oriented in the same direction, said method making use of three assembly arms, wherein said method makes use of control means which actuate said arms according to:
a first operating mode ensuring the assembly of the blanks with standard printing, said first operating mode making use of a first and a second assembly arm, by traction with the box at a point of reference, and
a second operating mode ensuring the assembly of the blanks with inverted printing, said second operating mode making use of a third arm and one of the arms from among the first and second assembly arms, by traction at said point of reference.

15. Assembling method according to claim 14, wherein the first operating mode commands:
the application of a first arm, a holding arm, against a first side of one of said opposite walls, and
the application of a second arm, an assembly arm, against a second side of the other of said opposite walls.

16. Assembling method according to claim 14, wherein the second operating mode commands:
the application of a first arm, a holding arm, against a first side of one of said opposite walls, and
the application of a third arm, an assembly arm, against a first side of the other of said opposite walls.

17. Facility for implementing the method according to claim 14, allowing the assembly, in the form of an open-ended box, of a cardboard blank of the slotted box type, said blank comprising two opposite walls joined by their lateral edges, each of the walls comprising two adjacent sides of the box to be formed, the two adjacent sides having different lengths, said blanks having standard or inverted printing oriented in the same direction,
said facility comprising an assembly station for assembling blanks into open-ended boxes,
said assembly station comprising three arms, and control means which can be actuated for first and second operating modes, wherein:
the first operating mode assembles blanks with standard printing by making use of a first and a second assembly arm, and
the second operating mode assembles blanks with inverted printing by making use of a third arm and one of the arms from among the first and second assembly arms.

18. Facility according to claim 17, wherein, among the three arms, the first arm is a first holding arm that maintains in position one of the walls of the blank lying horizontally, and wherein the first holding arm is mounted to move along a substantially vertical axis and along a substantially horizontal axis.

19. Facility according to claim 18, wherein the first arm comprises, at one of its ends, a flap that moves between a position where said flap is inactive and a position where said flap presses against an edge of said blank.

20. Facility according to claim 17, wherein, among the three arms, the second arm is an assembly arm that assembles the blank lying in a horizontal position, and wherein said second arm is an arm mounted to pivot on a substantially horizontal axis.

21. Facility according to claim 20, wherein said second assembly arm is mounted to overhang a slider bed on which said cardboard blank travels.

22. Facility according to claim 17, wherein, among the three arms, the third arm is an assembly arm that assembles the blank lying horizontally, and wherein said third arm is an arm mounted to move along a vertical axis.

23. Facility according to claim 22, comprising blocking means to stop the vertical movement of said third arm at a height substantially equal to the length of the smallest side of the blank, said means being operable when the third arm is rising.

24. Facility according to claim 22, comprising a numerical control axis ensuring the vertical displacement of said third arm.

25. Facility according to claim 22, wherein the third arm is mounted to pivot slightly at one end of an actuator.

26. Facility according to claim 17, wherein said assembly station comprises a flexible blade, equipped with an abutment acting as a point of reference for positioning and holding in place the front edge of a blank.
